(19) United States
(12) Patent Application Publication
(10) Pub. No.: US 2026/0180379 A1
(43) Pub. Date: Jun. 25, 2026

(54) STATOR AND METHOD FOR PRODUCING A STATOR

(71) Applicant: Schaeffler Technologies AG & Co. KG, Herzogenaurach (DE)

(72) Inventors: Florian Sell-Le Blanc, Karlsruhe (DE); Richard Bernauer, Weilheim (DE)

(73) Assignee: Schaeffler Technologies AG & Co. KG, Herzogenaurach (DE)

(21) Appl. No.: 19/123,778

(22) PCT Filed: Oct. 6, 2023
(86) PCT No.: PCT/DE2023/100744

§ 371 Date: Apr. 24, 2025

(30) Foreign Application Priority Data
Oct. 25, 2022 (DE) 10 2022 128 179.5

(51) Int. Cl. H02K 1/16; H02K 3/28; H02K 3/34; H02K 3/50

(52) U.S. Cl. CPC H02K 1/165; H02K 3/28; H02K 3/345; H02K 3/50

(57) ABSTRACT

A stator of an electric machine, such as for a drivetrain of a motor vehicle is provided. The stator includes a hollow-cylindrical stator body formed by a plurality of bundled stator laminations and a plurality of stator slots. The stator slots have a cross section with a U-shaped contour with two substantially parallel side walls, a slot base, and a slot opening lying radially opposite the slot base. A plurality of electrical conductors have a substantially rectangular conductor cross section and are arranged radially above one another in each stator slot forming a stator winding. The slot opening has a circumferential width smaller than a circumferential width of the electrical conductor radially closest to the slot opening. The electrical conductor radially closest to the slot opening is plastically deformed in the circumferential direction by being press-fit in the radial direction towards the slot base.

### CROSS-REFERENCE TO RELATED APPLICATIONS

This application is the United States National Phase of International Application PCT/DE2023/100744, filed Oct. 6, 2023, which claims priority to German Application 10 2022 128 179.5, filed Oct. 25, 2022. The disclosures of the above applications are incorporated herein by reference.

### TECHNICAL FIELD

The disclosure relates to a stator of an electric machine, such as for a drivetrain of a motor vehicle. The stator includes a hollow-cylindrical stator body which is formed by a plurality of bundled stator laminations and has a plurality of stator slots which extend axially through the stator body and have a cross section with a U-shaped contour with two substantially parallel side walls as well as a slot base and a slot opening lying radially opposite the slot base. A plurality of electrical conductors have a substantially rectangular conductor cross section and are arranged radially above one another in each stator slot to form a stator winding. The slot opening has a circumferential width which is smaller than a circumferential width of the electrical conductor radially closest to the slot opening, such that the electrical conductors are radially captively arranged in the respective stator slot. The disclosure further relates to a method for producing a stator.

### BACKGROUND

Electric motors are increasingly being used to drive motor vehicles in order to create alternatives to internal combustion engines that require fossil fuels. Significant efforts have already been made to improve the suitability of electric drives for everyday use and also to be able to offer users the driving comfort they are accustomed to.

A detailed description of an electric drive can be found in an article in the German automotive magazine ATZ, volume 63, 05/20 6, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for a vehicle axle having an electric motor arranged coaxially to a bevel gear differential. Such drive units are also known as e-axles.

In addition to purely electrically operated drivetrains, hybrid drivetrains are also known. Such drivetrains of a hybrid vehicle usually include a combination of an internal combustion engine and an electric motor, and enable, for example in urban areas, a purely electric mode of operation while at the same time permitting both sufficient range and availability, such as when driving cross-country. In addition, it is also possible to use the internal combustion engine and the electric motor at the same time for driving purposes in certain operating situations.

In addition to electromobility applications, electric machines are also used as electric motors for automation or as industrial motors, for example. Industrial motors are available in a wide variety of types with different quantities and requirements. One approach to mastering this diversity is to use common geometries, e.g., sheet metal sections, in order to then differentiate the product into the types with their properties via the interconnection of the individual coils.

Various winding technologies for a stator of an electric machine are known for the development of electric machines, such as electric machines for the above-mentioned hybrid or fully electric motor vehicles or for wheel hub drives.

Electric machines that have a stator with a hollow-cylindrical stator, i.e., are designed as an internal rotor machine, and which are configured for use as a traction drive in a motor vehicle, often have a stator winding with a rectangular cross section in order to achieve a high power density. The stator windings of electric machines intended for driving motor vehicles are therefore typically designed as shaft windings.

The structure of a stator with a shaft winding is a stator design in which winding mats are used to form the phase-specific windings. To form the distributed windings, the individual winding wires or partial mats are braided together, for example by a winding or layering process, and inserted into the stator slots. The shaft winding has a plurality of, usually three phases, where at least two separate wires or windings are usually provided for each phase. In each case, one winding is formed by a first and a second winding mat, where one winding mat carries the current in a clockwise direction and the other winding mat carries the current in a counterclockwise direction. The first winding mat runs from an axially extending phase input pin, for example counterclockwise, to an axially extending interconnection pin or alternatively has the pins. Via the interconnection pin, it is connected by way of an interconnection element to an interconnection pin of the second winding mat, which also extends axially and then runs clockwise to an axially extending phase output pin. This means that each phase-specific winding is formed by two winding mats connected in series and thus separate windings, which are connected via an interconnection element. With three phases and two or one separate winding(s) per phase, six or three windings are therefore provided. The phase output pins are in turn connected to each other via a common star switching element. The number of windings or wires is at least equal to the number of phases or a multiple thereof.

### SUMMARY

The disclosure provides a stator that is optimized in terms of its manufacturing and assembly costs. In addition, the disclosure provides a simplified method for producing a stator.

One aspect of the disclosure provides a stator of an electric machine, such as for a drivetrain of a motor vehicle. The stator includes a hollow-cylindrical stator body which is formed by a plurality of bundled stator laminations and a plurality of stator slots which extend axially through the stator body and have a cross section with a U-shaped contour with two substantially parallel side walls as well as a slot base and a slot opening lying radially opposite the slot base. A plurality of electrical conductors having a substantially rectangular conductor cross section are arranged radially above one another in the stator slots to form a stator winding. The slot opening has a circumferential width which is smaller than a circumferential width of the electrical conductor radially closest to the slot opening, such that the electrical conductors are radially captively arranged in the respective stator slot. The electrical conductor radially closest to the slot opening is plastically deformed in the circumferential direction by way of press fitting in the radial direction towards the slot base.

This has the advantage that there is no need for an additional slot locking means, such as a slot locking wedge, in order to captively arrange the electrical conductors in the stator slots. For this purpose, the rectangular wire geometries of the electrical conductors in the stator slots are formed without cutting by press fitting in order to create a greater width than that of the slot opening.

For example, the stator winding can initially be fixed in the stator body's stator slots by self-locking. The necessary degree of deformation of the electrical conductor is minimal compared to complete winding compression, so that there is only a very low risk of insulation damage. It is also possible to increase the fill factor of the stator winding in the stator slots. The fact that the entire stator winding can be formed simultaneously in the stator slots of the stator that the applied pressing forces can be better distributed in the stator or cancel each other out, so that the risk of local deformations is also low.

The stator is intended for use in an electric machine. The electric machine is used to convert electrical energy into mechanical energy and/or vice versa, and generally includes a stationary part referred to as a stator, stand, or armature, and a part referred to as a rotor or runner, and arranged movably, such as rotatably, relative to the stationary part. In some examples, the electric machine is dimensioned such that vehicle speeds of more than 50 km/h, such as more than 80 km/h and for example more than 100 km/h can be achieved. The electric motor may have an output of more than 10 KW, for example more than 30 kW, such as more than 50 kW and for instance more than 70 kW. Furthermore, in some implementations the electric machine provides speeds greater than 5,000 rpm, such as greater than 10,000 rpm, for example greater than 12,500 rpm. In the case of external rotors such as wheel hub drives, the corresponding electric machine can provide speeds of up to 1,500 rpm.

In some implementations, the stator can be energized by power electronics. The power electronics may be a combination of various components which control or regulate a current at the stator, such as including the peripheral components required for this, such as cooling elements or power supply units. In some examples, the power electronics contain one or more power electronics components which are set up to control or regulate a current. These may be one or more power switches, e.g., power transistors. The power electronics may have more than two, and such as three, separate phases or current paths, each with at least one separate power electronics component. The power electronics may be designed to control or regulate a power with a peak power, such as continuous power, of at least 10 W, for example at least 100 W, for instance at least 1000 W per phase. The power electronics may be connected to the stator winding of the stator via an HV terminal (HV=high voltage).

For the purposes of this application, motor vehicles are land vehicles which are moved by machine power without being bound to railroad tracks. A motor vehicle can be selected, for example, from the group of passenger cars, trucks, small motorcycles, light motor vehicles, motorcycles, motor buses/coaches or tractors.

The stator may be configured for a radial flux machine. The stator of a radial flux machine usually has a cylindrical or cylindrical ring-shaped structure and generally includes a stator body which is formed from electrical laminations that are electrically insulated from one another and are structured in layers and packaged to form laminated cores. With this structure, the eddy currents in the stator caused by the stator field are kept low. Distributed around the circumference, stator slots are embedded into the electrical lamination extending parallel to the rotor shaft, which receive the stator winding or parts of the stator winding. Depending on the construction towards the surface, the slots can be closed with closing elements, such as closing wedges or covers or the like, to prevent the stator winding from detaching.

In some implementations, the stator body is designed in one piece. A one-piece stator body is characterized by the fact that the entire stator body is formed in one piece as viewed over the circumference. The stator body is usually formed from a plurality of stacked laminated electrical sheets (electrical laminations), where each of the electrical laminations is closed to form a circular ring. The individual laminations can be held together in the stator body, for example by adhesive bonding, welding or screwing.

In some examples, the stator teeth of the stator are formed in the stator body. Stator teeth are components of the stator body that are designed as circumferentially spaced, tooth-like parts of the stator body directed radially inwards (internal rotor) or radially outwards (external rotor) and between the free ends and a rotor body an air gap is formed for the magnetic field and for the rotational movement of the rotor. The existing non-magnetic gap between the rotor and the stator is referred to as the air gap. In a radial flux machine, this is a substantially annular gap with a radial width that corresponds to the distance between the rotor body and the stator body, for example.

In some implementations, a stator winding is embedded in the stator slots of the stator. A stator winding includes electrically conductive conductors which have a longitudinal extension that is much greater than their diameter. The stator winding can generally have any cross-sectional shape. In some examples, rectangular cross-sectional shapes are used, as these allow for high packing densities and consequently high power densities to be achieved. In some implementations, a stator winding is formed of copper. The stator winding may be designed as a continuous shaft winding. Furthermore, the electrical conductors may have a substantially identical cross section before being inserted into the stator slots. In some examples, the electrical conductors have an electrical insulation layer.

In some implementations, the stator slots each have a circumferential slot width, where the circumferential width of the electrical conductor radially closest to the slot opening is smaller than the circumferential slot width. The advantage of this design is that there is still clearance between the slot walls and the electrical conductor at the slot opening, which ensures that the electrical conductor flows into the stator slot and thus ensures sufficient cooling in this area.

In some implementations, the electrical conductor radially closest to the slot opening has, on its longitudinal side facing the slot opening, a slot-like section in cross section pointing in the direction of the slot base, which was formed by press fitting with a convex punch. As a result, a press fitting of material in both circumferential directions can be achieved with comparatively low radial compressive forces.

In some examples, a defined distance between the pole piece geometry or the air gap and the first electrical conductor is defined by providing a conical slot geometry and fixing the first conductor at the defined position for the press fitting process. This defined distance can either fulfill the function of a necessary air and creepage distance or be selected in such a way that losses caused by induction of the rotor field in the first conductor near the air gap are minimized

Furthermore, in some implementations, the electrical conductors have a coating made of an electrically insulating material. The advantageous effect of this design is that a high dielectric strength is provided and minimal clearance and creepage distances are required. The coating is preferably a PEEK coating.

In the case of particular requirements for the clearance and creepage distance, an insulator, such as a Nomex insulating paper, lying on the winding as a surface insulating element, which is intended to be press fitted together with the electrical conductor in such a way that a fixed assembly of the surface insulating element is ensured due to the form fit. The form fit can be realized via a clamping on the surfaces of the slot flanks or via the designed slot shape of the punch or the resulting slot shape of the conductor. The use of thinner surface insulation elements represents an advantage in terms of product costs and installation space compared to the usual plastic-based solid bodies used as slot closure wedges.

In some implementations, an insulator is in contact with the side walls and the base of the slot in each of the stator slots. The insulator may be an insulating paper. The advantage of this design is that the insulation of the electrical conductors from the stator body can be further improved.

Another aspect of the disclosure provides a method for producing a stator of an electric machine, such as for a drivetrain of a motor vehicle. The method includes:
providing a hollow-cylindrical stator body that is formed by a plurality of stacked stator laminations and has a plurality of stator slots which extend axially through the stator body, and have a cross section with a U-shaped contour with two substantially parallel side walls as well as a slot base and a slot opening lying radially opposite the slot base,
providing a plurality of electrical conductors having a substantially rectangular conductor cross section to form a stator winding,
inserting the electrical conductors into the stator slots from the radial direction through each one of the slot openings in the direction of the slot base, such that in each case a plurality of electrical conductors are arranged radially above one another in a stator slot, where the slot opening has a circumferential width which is greater than a circumferential width of the electrical conductors,
press fitting the electrical conductor radially closest to the slot opening by means of a punch, which engages through the slot opening in the radial direction towards the slot base and plastically deforms the electrical conductor radially closest to the slot opening in the circumferential direction, such that the circumferential width of the electrical conductor radially closest to the slot opening is greater than the circumferential width of the slot opening and the electrical conductors are radially captively arranged in the respective stator slot.

The output wire of the electrical conductors can be a classic rectangular wire, such as with a PEEK coating in order to generate a high dielectric strength and require minimal clearance and creepage distances. In the classic expansion process for the flat wire shaft winding arranged in the stator slots, the radial joining process is not terminated when the electrical conductors reach their final position in the stator slots, but rather a forming process of the electrical conductors is initiated after the insertion process. The wire cross section of the electrical conductor radially closest to the slot opening is thereby changed in the stator slot such that its wire width becomes greater than the opening of the stator slot, but does not yet reach the full slot width. After forming, the assembly punch is retracted radially from the stator slot.

In some implementations, the cross section of the punch has a convex contour facing the electrical conductor. The advantage that can be realized here is that a material offset can be achieved on both sides of the electrical conductor in the circumferential direction, which reduces the radial compressive forces required for press fitting.

In some examples, the stator slots each have a circumferential slot width, where the press fitting is set such that the circumferential width of the electrical conductor radially closest to the slot opening is smaller than the circumferential slot width after the plastic deformation has been carried out.

This allows gaps to be maintained on both sides of the electrical conductor towards the slot walls, through which a cooling fluid can flow, for example, which can contribute to efficient heat dissipation from these areas. This can also reduce the risk of mechanical damage to an insulating medium.

In some implementations, an insulator is arranged on the side walls and the base of the stator slots before the electrical conductors are inserted, which further improves the electrical insulation of the electrical conductors with respect to the stator body.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a motor vehicle with an electric drive train in a schematic block diagram,

FIG. 2 shows an electric machine in a schematic cross-sectional view,

FIG. 3 shows a detailed representation of a stator slot in a cross-sectional view,

FIG. 4 shows four successive assembly states during the insertion of electrical conductors into a stator slot, in a cross-sectional view in each case,

FIG. 5 shows four successive assembly states during the press fitting of the electrical conductors in a stator slot, in a cross-sectional view in each case,

FIG. 6 shows three successive assembly states during the press fitting of the electrical conductors with a second exemplary punch, in a cross-sectional view in each case.

Like reference symbols in the various drawings indicate like elements.

### DETAILED DESCRIPTION

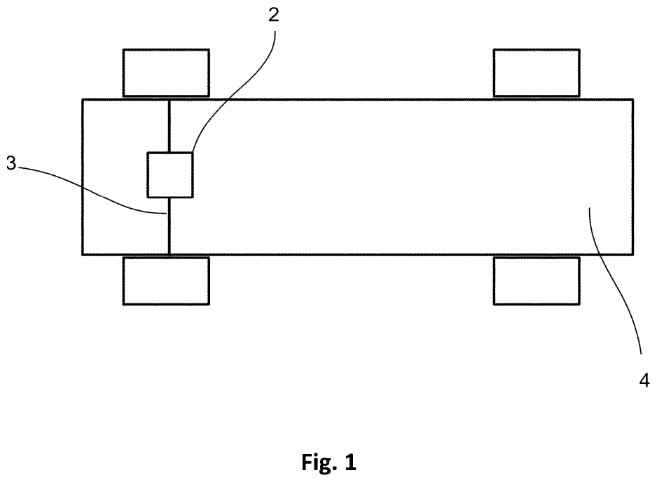

A stator 1 of an electric machine 2 for a drivetrain 3 of a motor vehicle 4 is shown in FIG. 1.

The stator 1 is formed by a plurality of bundled stator laminations 5, which form a hollow-cylindrical stator body 6. The rotor 16 is mounted inside the stator body 6 so that it can rotate coaxially therewith. As shown, the electric machine 2 is designed as an internal rotor.

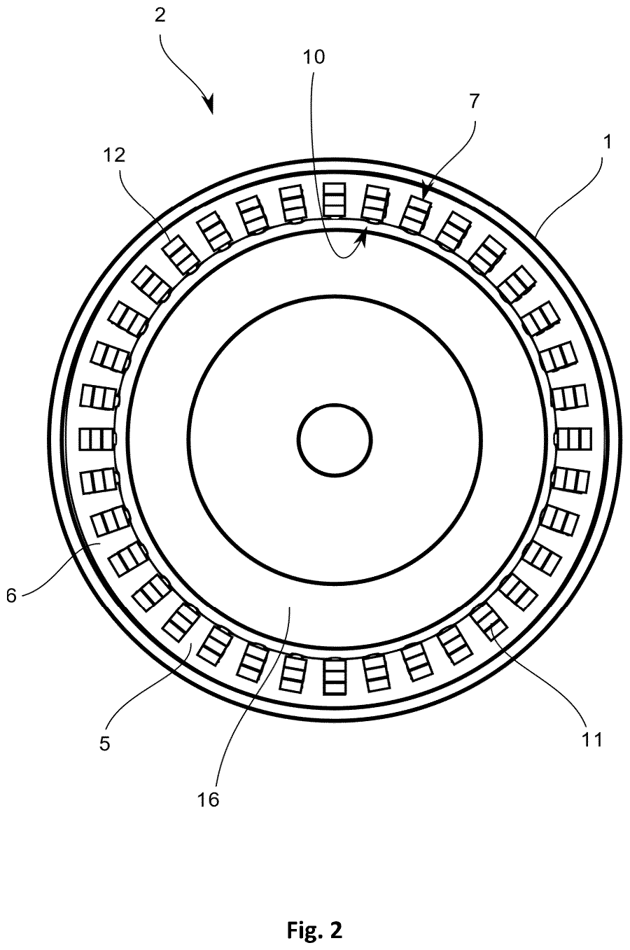

The stator body 6 is provided with a plurality of stator slots 7 extending axially through the stator body 6 and arranged equidistantly around the circumference, which have a cross section with a U-shaped contour with two substantially parallel side walls 8 as well as a slot base 9 and a slot opening 10 lying radially opposite the slot base 9, which can be easily understood from FIG. 2. The stator teeth 18 extend radially inwards from the circular ring-shaped stator yoke, so that the stator slots 7 are defined between the stator teeth 18.

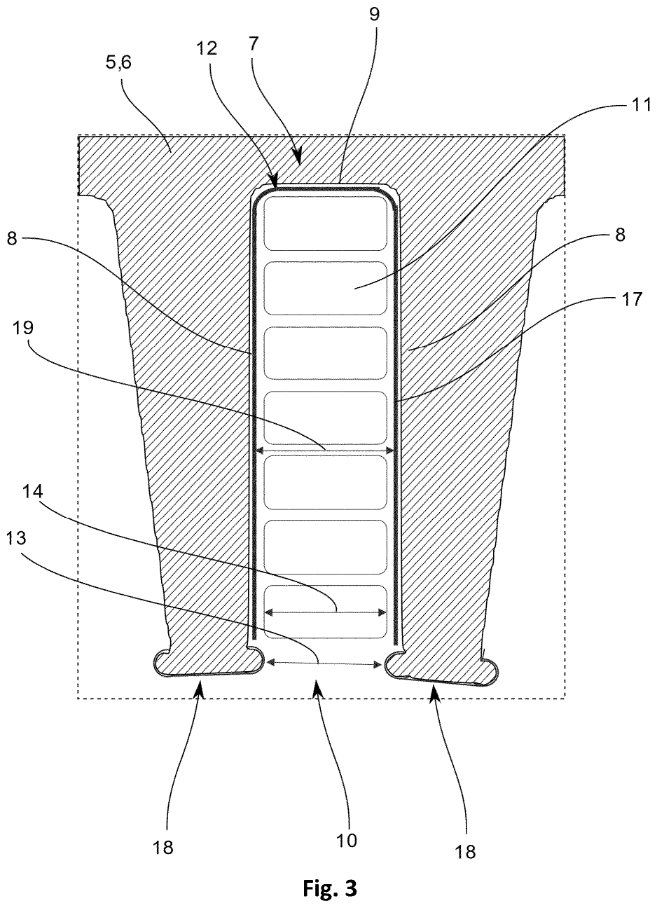

A plurality of electrical conductors 11 having a substantially rectangular conductor cross section are arranged radially above one another in each stator slot 7 to form a stator winding 12. The slot opening 10 has a circumferential width 13 which is smaller than the circumferential width 14 of the electrical conductor 11 radially closest to the slot opening 10, such that the electrical conductors 11 are radially captively arranged in the respective stator slot 7, as shown in FIG. 3.

The electrical conductor 11 radially closest to the slot opening 10 was plastically deformed in the circumferential direction by press fitting in the radial direction towards the slot base 9. FIG. 3 also shows that the stator slots 7 each have a circumferential slot width 19, where the circumferential width 14 of the electrical conductor 11 radially closest to the slot opening 10 is smaller than the circumferential slot width 19. As shown, the electrical conductors 11 have a coating made of an electrically insulating material. FIG. 3 also shows that in each of the stator slots 7, an insulator 17 is in contact with the side walls 8 and the slot base 9. As shown, the insulator 17 is an insulating paper.

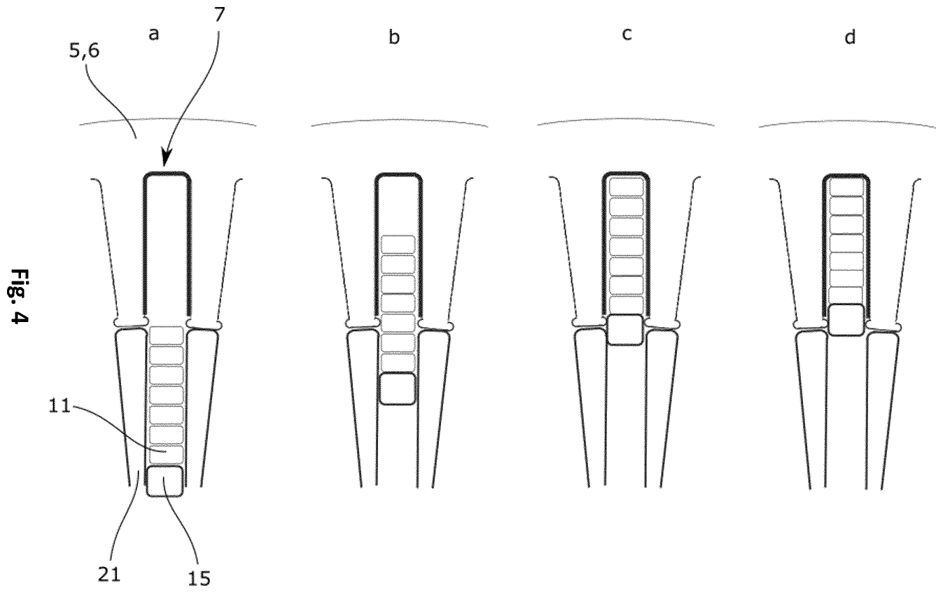

A possible method for producing the stator known from FIGS. 2-3 is now explained in more detail with reference to FIGS. 4-6.

First, a hollow-cylindrical stator body 6 is provided which is formed by a plurality of bundled stator laminations 5 and has a plurality of stator slots 7 which extend axially through the stator body 6 and have a cross section with a U-shaped contour with two substantially parallel side walls 8 as well as a slot base 9 and a slot opening 10 lying radially opposite the slot base 9. Furthermore, a plurality of electrical conductors 11 having a substantially rectangular conductor cross section are provided to form a stator winding 12

An insulator 17 is arranged on the side walls 8 and the slot base 9 of the stator slots 7 before the electrical conductors 11 are inserted. The electrical conductors 11 are then inserted into the stator slots 7 from the radial direction through each one of the slot openings 10 in the direction of the slot base 9, such that in each case a plurality of electrical conductors 11 are arranged radially above one another in a stator slot 7, where the slot opening 10 has a circumferential width 13 which is greater than a circumferential width 14 of the electrical conductors 11. These production states can be seen in illustrations a-d in FIG. 3. When the conductors 11 are inserted, they and the punch 15 are guided through the tool 21 in a radial direction outside the stator slot 7. The punch 15 then presses the electrical conductors 11 in a radial direction from the inside to the outside into the stator slot 7.

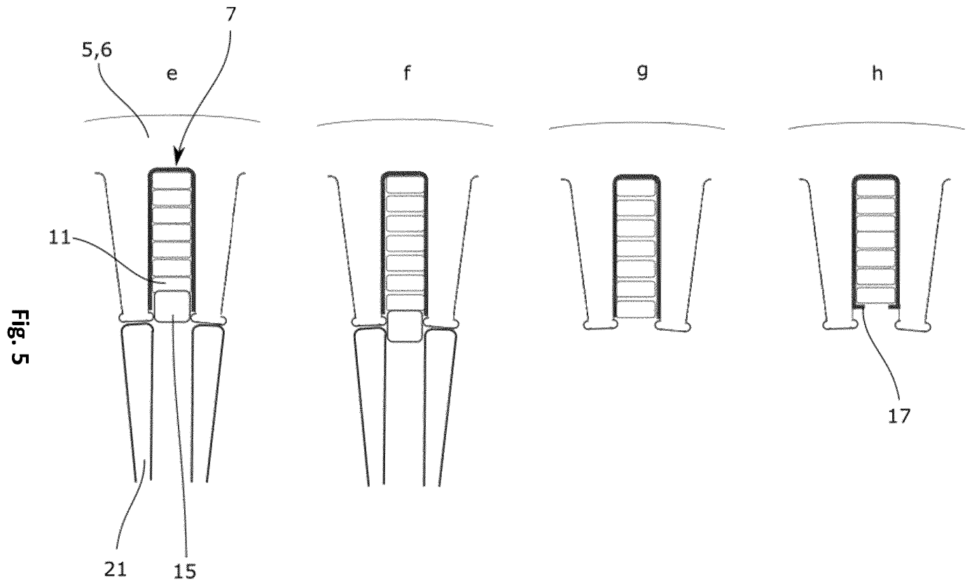

After the electrical conductors 11 have been completely positioned in the stator slot 7, the electrical conductor 11 radially closest to the slot opening 10 is then press fitted by way of a punch 15, which engages through the slot opening 10 in the radial direction towards the slot base 9 and plastically deforms the electrical conductor 11 radially closest to the slot opening 10 in the circumferential direction, such that the circumferential width 14 of the electrical conductor 11 radially closest to the slot opening is greater than the circumferential width 13 of the slot opening 10 and the electrical conductors 11 are radially captively arranged in the respective stator slot 7. This can be seen in illustrations e-f of FIG. 5.

After press fitting, the punch 15 is pulled radially out of the stator slot 7 and the tool 21 is removed, resulting in the assembly state shown in figure g of FIG. 4. Subsequently, the insulator 17 can be folded inwards into the stator slot 7 at the ends facing the slot opening 10, as can be seen in illustration h in FIG. 4.

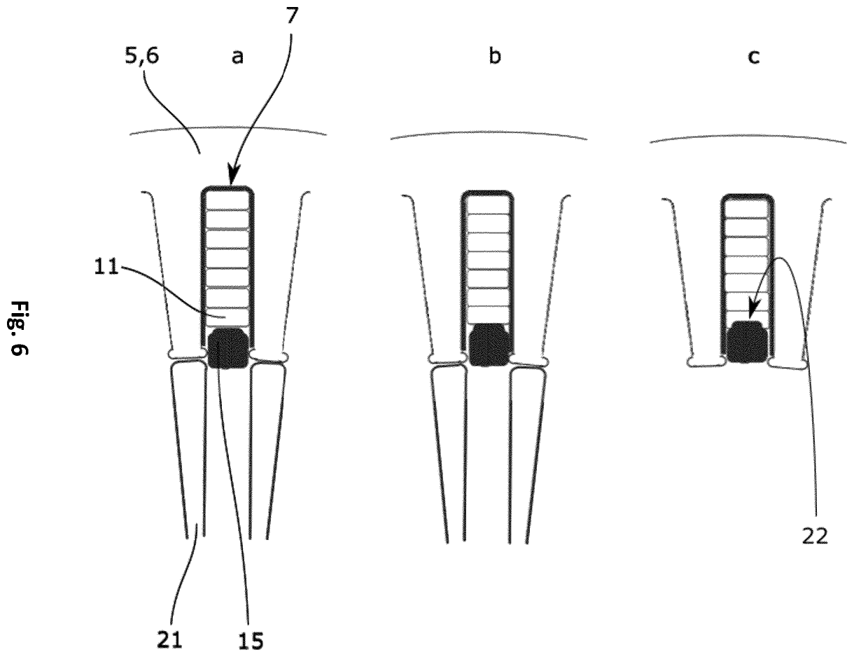

FIG. 6 shows an example of the punch 15 in which the cross section of the punch 15 has a convex contour facing the electrical conductor 11. As a result, a slot-like section 20 in cross section pointing in the direction of the slot base 9 can be impressed on the longitudinal side 22 of the electrical conductor 11 radially closest to the slot opening facing the slot opening 10.

FIGS. 4-5 also show that the stator slots 7 each have a circumferential slot width 19, where the press fit is set such that the circumferential width 14 of the electrical conductor 11 radially closest to the slot opening 10 is smaller than the circumferential slot width 19 after the plastic deformation has been carried out.

As shown in FIGS. 2-6, an unequal number of electrical conductors 11 are arranged in the stator slots 7. It is understood that the number of electrical conductors 11 in the stator slots 7 can also be even if the stator winding 12 is designed as a shaft winding, for example.

A number of implementations have been described. The above description is therefore not to be regarded as restrictive, but rather as explanatory. The following claims are to be understood as meaning that a stated feature is present in at least one implementation of the disclosure. This does not exclude the presence of further features. Where the claims and the above description define ‘first’ and ‘second’ features, this designation serves to distinguish between two features of the same type without defining an order of precedence.

### REFERENCE NUMERALS

1 Stator
2 Electric machine
3 Drivetrain
4 Motor vehicle
5 Stator sheets
6 Stator body
7 Stator slots
8 Side walls
9 Slot base
10 Slot opening
11 Electrical conductor
12 Stator winding
13 Width
14 Width
15 Punch
16 Rotor
17 Insulator
18 Stator tooth
19 Slot width
20 Slot-like section
21 Tool
22 Longitudinal side

1. A stator of an electric machine for a drivetrain of a motor vehicle, the stator comprising:
a hollow-cylindrical stator body formed by a plurality of bundled stator laminations and having a plurality of stator slots extending axially through the stator body and having a cross section with a U-shaped contour with two substantially parallel side walls as well as a slot base and a slot opening lying radially opposite the slot base; and
a plurality of electrical conductors having a substantially rectangular conductor cross section are arranged radially above one another in each stator slot to form a stator winding,
wherein the slot opening has a circumferential width which is smaller than a circumferential width of the electrical conductor radially closest to the slot opening, such that the electrical conductors are radially captively arranged in the respective stator slot, and
wherein the electrical conductor radially closest to the slot opening is plastically deformed in the circumferential direction by press fitting in the radial direction towards the slot base.

2. The stator of claim 1, wherein the stator slots each have a circumferential slot width, the circumferential width of the electrical conductor radially closest to the slot opening is smaller than the circumferential slot width.

3. The stator of claim 1, wherein the electrical conductor radially closest to the slot opening has, on its longitudinal side facing the slot opening, a slot-like section in cross section pointing in a direction of the slot base.

4. The stator of claim 1, wherein the electrical conductors have a coating made of an electrically insulating material.

5. The stator of claim 1, wherein in each of the stator slots, an insulator is in contact with the side walls and the slot base.

6. The stator of claim 5, wherein the insulator is an insulating paper.

7. A method for producing a stator of an electric machine for a drivetrain of a motor vehicle, the method comprising:
providing a hollow-cylindrical stator body formed by a plurality of bundled stator laminations and having a plurality of stator slots extending axially through the stator body (6) and having a cross section with a U-shaped contour with two substantially parallel side walls (8) as well as a slot base (9) and a slot opening lying radially opposite the slot base;
providing a plurality of electrical conductors having a substantially rectangular conductor cross section to form a stator winding;
inserting the electrical conductors into the stator slots from the radial direction through each one of the slot openings in a direction of the slot base, such that in each case a plurality of electrical conductors are arranged radially above one another in a stator slot, wherein the slot opening has a circumferential width which is greater than a circumferential width of the electrical conductors; and
press fitting the electrical conductor radially closest to the slot opening by a punch, which engages through the slot opening in the radial direction towards the slot base and plastically deforms the electrical conductor radially closest to the slot opening in the circumferential direction, such that the circumferential width of the electrical conductor radially closest to the slot opening is greater than the circumferential width of the slot opening and the electrical conductors are radially captively arranged in the respective stator slot.

8. The method of claim 7, wherein the punch has a convex cross-sectional contour facing the electrical conductor.

9. The method of claim 7, wherein the stator slots each have a circumferential slot width, wherein the press fit is set such that the circumferential width of the electrical conductor radially closest to the slot opening is smaller than the circumferential slot width after the plastic deformation has been carried out.

10. The method of claim 7, wherein an insulator is arranged on the side walls and the slot base of the stator slots before the electrical conductors are inserted.
